(19) United States
(12) Patent Application Publication
(10) Pub. No.: US 2026/0131918 A1
(43) Pub. Date: May 14, 2026

(54) TRAILER FOR USE WITH OPERATING DRONES AND METHOD OF USE

(71) Applicant: HLE Drones, LLC, Dundee, OH (US)

(72) Inventor: Michael YODER, Dundee, OH (US)

(73) Assignee: HLE Drones, LLC, Dundee, OH (US)

(21) Appl. No.: 18/945,773

(22) Filed: Nov. 13, 2024

(51) Int. Cl. B64U 80/86; B64U 80/25; B64U 80/40

(52) U.S. Cl. CPC B64U 80/86; B64U 80/25; B64U 80/40

(57) ABSTRACT

A trailer for use with a drone having a bed and a deck, where the deck is vertically above the bed and operably engaged with the bed. The bed is adapted to engage with a moving apparatus. The trailer also has a base provided on the deck and the base is a substantially continuous single sheet of material. The base also can be comprised of a single sheet of composite material. The base also has a perimeter which is sealed to a frame of the deck. The trailer also has equipment mounted to the bed. The equipment is one or more of a plumbing assembly and an electrical assembly.

### TECHNICAL FIELD

The present disclosure relates generally to trailers used to haul items. More particularly, the present disclosure relates to a trailer used for launching and controlling drones. Specifically, the present disclosure is directed to a trailer used for operating drones for agricultural purposes.

### BACKGROUND ART

Since their introduction, drones have become commonplace in various industries. In recent years, agricultural professionals have found that drones can be useful in their industry. Previously, agricultural professionals would need to wait for perfect conditions to be able to drive heavy machinery into fields in order to spray crops with fertilizers, insecticides, fungicides, and/or herbicides. Drones have now been developed which allow an agricultural professional to spray crops without having to move heavy machinery into the fields. Spraying can therefore be undertaken without having to wait for perfect conditions.

Agriculture drone professionals need an efficient way to move all the equipment and chemicals involved with operating agricultural drones from one location to another. Typically, the equipment and chemicals are placed inside a trailer which is then hauled to a location close to the fields that need to be sprayed. The agricultural drone professional will utilize the area around the trailer to set up their equipment. When spraying is completed, the equipment will be returned to the trailer and will be moved to the next site.

### SUMMARY OF THE INVENTION

The trailer in accordance with the present disclosure enables an agricultural drone professional to quickly and easily move all equipment and chemicals required for spraying crops from one location to another. The presently disclosed trailer has the necessary equipment permanently mounted to the trailer and enables the drone professional to operate agricultural drones from a safer and more effective vantage point.

In one aspect, an exemplary embodiment of the present disclosure may provide a trailer for use with a drone comprising a bed adapted to be engaged with a moving apparatus, a deck located vertically above the bed and operably engaged with the bed, a base provided on the deck, wherein the base comprises a substantially continuous single sheet of material.

In another aspect, an exemplary embodiment of the present disclosure may provide where the base is comprised of a single sheet of a composite material. In another aspect, an exemplary embodiment of the present disclosure may provide where the base has a perimeter which is sealed to a frame of the deck. In another aspect, an exemplary embodiment of the present disclosure may provide where the frame of the deck defines a peripheral wall extending upwardly beyond the perimeter of the base. In another aspect, an exemplary embodiment of the present disclosure may provide where the base is leak proof. In another aspect, an exemplary embodiment of the present disclosure may provide further comprising an anchor provided on the deck, wherein the anchor is adapted to engage and secure a drone to the deck. In another aspect, an exemplary embodiment of the present disclosure may provide further comprising a staircase extending between the bed and the deck. In another aspect, an exemplary embodiment of the present disclosure may provide further comprising a hole defined in the deck proximate the staircase and a door operably engaged with the deck, wherein the door is movable between an open position and a closed position, and when in the open position, access to the staircase is enabled. In another aspect, an exemplary embodiment of the present disclosure may provide further comprising equipment mounted on the bed, where the equipment is open to the environment. In another aspect, an exemplary embodiment of the present disclosure may provide where the equipment comprises one or more of a plumbing assembly and an electrical assembly. In another aspect, an exemplary embodiment of the present disclosure may provide where the plumbing assembly comprises a hose reel mounted on the deck, where the hose reel is positioned below a lower surface of the deck. In another aspect, an exemplary embodiment of the present disclosure may provide where the plumbing assembly further comprises a first tank adapted to hole a volume of a first liquid, a second tank adapted to hose a volume of a second liquid, and a pump operably engaged with one or both of the first tank and the second tank. In another aspect, an exemplary embodiment of the present disclosure may provide where the plumbing assembly further comprises a nozzle provided on the deck and connected to a hose mounted on the hose reel, wherein the hose and nozzle are operably engaged with the one or both of the first tank and the second tank. In another aspect, an exemplary embodiment of the present disclosure may provide where the electrical assembly comprises at least one battery charger operably engaged with the deck, wherein the at least one battery charger is mounted below a lower surface of the deck. In another aspect, an exemplary embodiment of the present disclosure may provide where the electrical assembly further comprises a generator located on the bed where the at least one battery charger is operably engaged with the generator. In another aspect, an exemplary embodiment of the present disclosure may provide further comprising a railing extending upwardly around at least a portion of the deck, wherein the railing defines a safety zone for an operator on the deck. In another aspect, an exemplary embodiment of the present disclosure may provide further comprising a mounting bracket on the railing, wherein the mounting bracket is adapted to operably engage a controller for the drone to the railing.

In one aspect, an exemplary embodiment of the present disclosure may provide a method of using a trailer for use with a drone, comprising providing the trailer having a bed, engaging a deck vertically above the bed, providing a base on the deck, wherein the base is leak proof, engaging the trailer to a moving apparatus via the bed, placing a drone atop the base, moving the trailer via the moving apparatus to a desired position, and operating a drone from the deck of the trailer.

In another aspect, and exemplary embodiment of the present disclosure may provide providing an anchor on the deck and releasably securing the drone to the deck via the anchor. In another aspect, and exemplary embodiment of the present disclosure may provide providing a plumbing assembly on the trailer, positioning a hose reel of the plumbing assembly below a lower surface of the deck, securing the hose reel to the deck of the trailer, providing a nozzle of the plumbing assembly above the deck, operably engaging the nozzle with a hose located on the hose reel, and filling the drone with a desired liquid via the nozzle. In another aspect, and exemplary embodiment of the present disclosure may provide providing an electrical assembly on the trailer, providing a battery charger as part of the electrical assembly, and accessing the battery charger while standing atop the deck. In another aspect, and exemplary embodiment of the present disclosure may provide positioning a holder for the battery charger below a lower surface of the deck, securing the holder to the deck, and inserting the battery charger into the holder. In another aspect, and exemplary embodiment of the present disclosure may provide engaging a single continuous sheet of material on an upper surface of the deck.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is front, top, right side isometric view of a trailer in accordance with the present disclosure, shown attached to a vehicle.

FIG. 2 is a front, top, right side isometric view of the trailer of FIG. 1, shown in isolation.

FIG. 3 is a top plan view of the trailer.

FIG. 4 is a right side elevation view of the trailer.

FIG. 5 is a left side elevation view of the trailer.

FIG. 6 is an enlarged first partial front, top, left side isometric view of the trailer, showing one of the charging ports in an open position.

FIG. 7 is an enlarged second partial front, top, left side isometric view of the trailer, showing the filling nozzle and hose reel.

FIG. 8 is an enlarged cross-section of the deck of the trailer taken along line 8-8 of FIG. 6.

FIG. 9 is a left side elevation view of the trailer showing a drainage assembly provided thereon and with all other components omitted for clarity of illustration.

Similar numbers refer to similar parts throughout the drawings.

### DETAILED DESCRIPTION

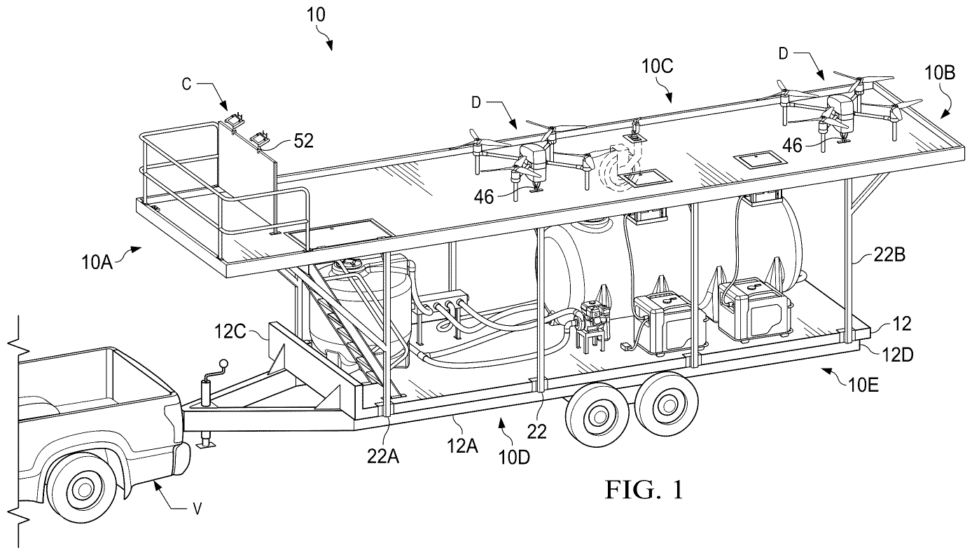

Referring to FIGS. 1-8, there is shown a trailer in accordance with the present disclosure, generally indicated at 10. Trailer 10 generally includes a front 10A and a rear 10B located opposite one another and spaced a distance longitudinally apart from one another. Trailer 10 generally includes a top 10C and a bottom 10D located opposite one another and spaced a distance vertically apart from one another. Trailer 10 further generally includes a left side 10E and a right side 10F located opposite one another and spaced a distance laterally apart from one another.

Trailer 10 generally includes a bed 12 and a deck 14, where deck 14 is spaced a distance vertically above the bed 12. Trailer 10 is configured to house at least one piece of equipment on bed 12 and/or deck 14.

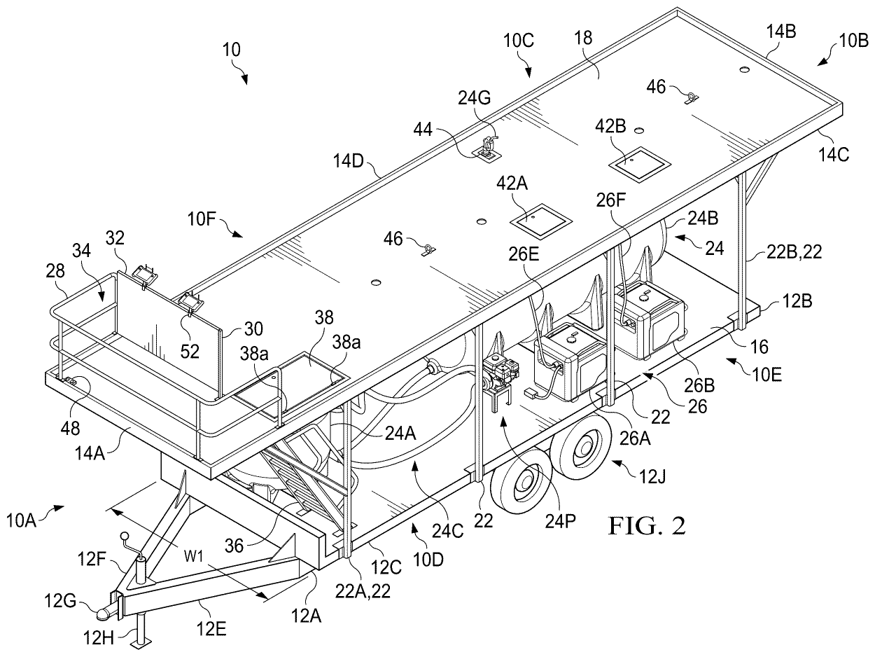

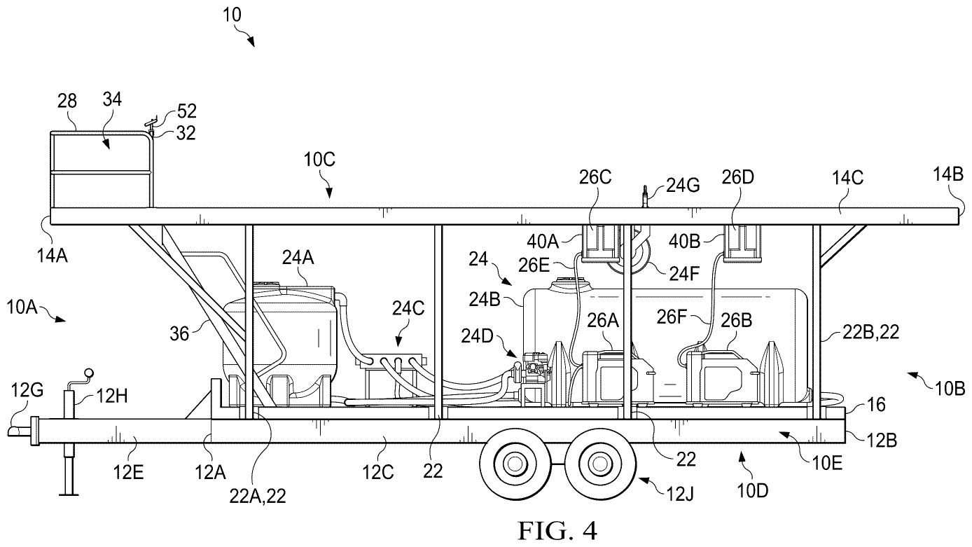

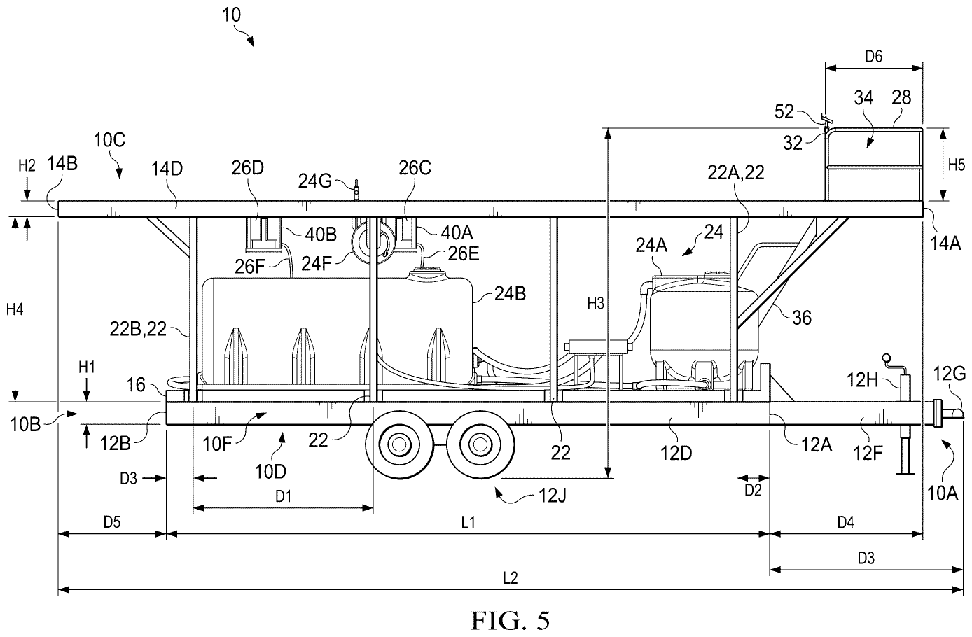

Referring to FIGS. 1-5, bed 12 includes a frame comprised of at least a first member 12A, a second member 12B, a third member 12C, and a fourth member 12D. First and second members 12A (FIG. 4), 12B (FIG. 5) extend longitudinally between front 10A and rear 10B of trailer 10. First and second members 12A, 12B are opposed to one another and are arranged parallel to one another. First and second members 12A, 12B are spaced apart a first width “W1” (FIG. 2) apart from one another. Third and fourth members 12C, 12D extend laterally between first and second members 12A, 12B and therefore extend between left side 10E and right side 10F of trailer 10. Third and fourth members 12C, 12D are opposed to one another and are arranged parallel to one another. Third and fourth members 12C, 12D are spaced a first length “L1” (FIG. 5) apart from one another. Each of the first, second, third, and fourth members 12A, 12B, 12C, 12D comprises a rolled metal component which is welded or otherwise secured at each end to an end of an adjacent member to form a unitary component.

Although not pictured in the attached figures, the frame of bed 12 may include a plurality of cross members extending between first and second members 12A, 12B and a plurality of beams extending between third and fourth members 12C, 12D. Each of first, second, third and fourth member 12A, 12B, 12C, 12D is of a first height “H1” (FIG. 5).

Referring to FIG. 2, the frame of bed 12 further includes a tongue which extends forwardly from third member 12C. The tongue comprises a first tongue beam 12E and a second tongue beam 12F extending outwardly at an angle from a first end of first and second frame members 12A, 12B, respectively. First and second tongue beams 12E, 12F meet at a hitch assembly 12G. Hitch assembly 12G at the front 10A of trailer 10 is adapted to be selectively engageable with a vehicle “V” (FIG. 1) so that trailer 10 may be towed. A trailer jack 12H is provided on the tongue proximate the hitch assembly 12G. The trailer jack 12H is configured to selectively support the tongue a distance above the ground when the trailer 10 is not hitched to vehicle “V”.

Bed 12 further includes a plurality of wheel assemblies 12J which are operatively engaged with the frame of the bed 12.

A floor 16 is operably engaged with the frame of bed 12. The floor extends between first, second, third, and fourth members 12A, 12B, 12C, 12D and is configured to hold and support a number of pieces of equipment as will be described later herein. In one embodiment, the floor 16 is made of wood. It will be understood that floor 16 may alternatively be made of any other material suitable for supporting the various pieces of equipment thereon.

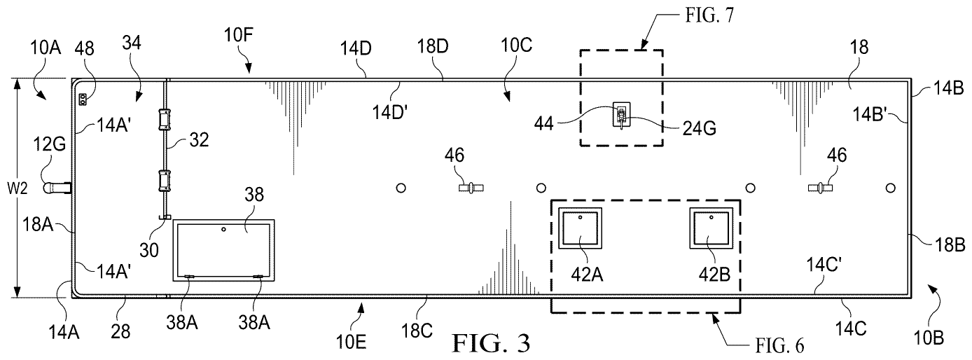

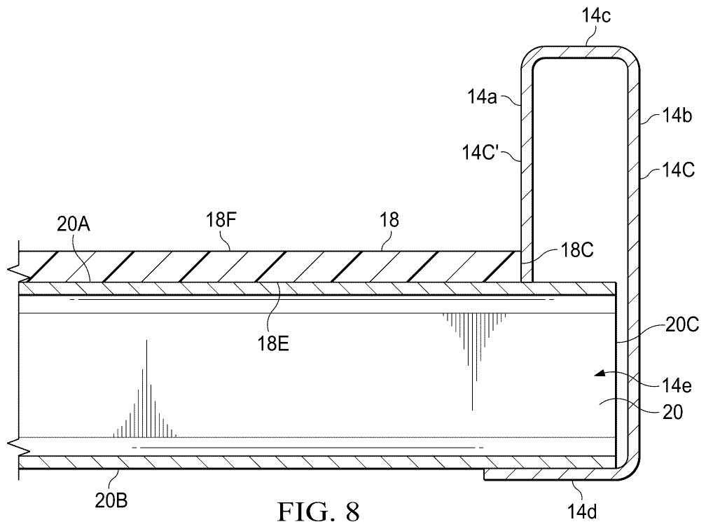

Referring to FIGS. 1-5 and as best seen in FIG. 3, deck 14 includes a frame comprising at least a first element 14A, a second element 14B, a third element 14C, and a fourth element 14D. Each of the first, second, third, and fourth elements 14A, 14B, 14C, 14D comprises a rolled metal component which is welded or otherwise secured at each end to an end of an adjacent member to form the frame. First and second elements 14A, 14B extend transversely between left and right sides 10E, 10F of trailer, are opposed to one another, and are arranged parallel to one another. First and second elements 14A, 14B are located a second length “L2” apart. Third and fourth elements 14C, 14B extend longitudinally between first and second ends 10A, 10B of trailer, are opposed to one another, and are arranged parallel to one another. Third and fourth elements 14C, 14B are located a second width “W2” apart. Each of first, second, third and fourth elements 14A, 14B, 14C, 14D is of a second height “H2” (FIG. 5). A plurality of cross members extends between third and fourth elements 14C, 14D. FIG. 8 shows a portion of a single cross element 20 which extends between third and fourth elements 14C, 14D. Each cross element, such as cross element 20 includes an upper surface 20A and a lower surface 20B located a distance vertically apart and opposite one another. Cross element 20 includes a first end 20C engaged with third element 14C and a second end (not shown) engaged with fourth element 14D.

It will be understood that third element 14C and fourth element 14D are substantially identical to one another and the following description of third element 14C and its engagement with first end 20C of cross element 20 will equally apply to fourth element 14D and its engagement with the second end (not shown) of cross element 20.

Referring to FIG. 8, third element 14C includes a first side wall 14a and a second side wall 14b which are oriented vertically, are located opposite one another, and spaced a distance apart from one another. Third element 14C further includes a top wall 14c extending between first and second side wall 14a, 14b and a bottom wall 14d opposite top wall 14c. An aperture 14e is defined in a lower region of first side wall 14a and is configured to receive the first end 20C of cross element 20 therein. Bottom wall 14d extends from second side wall 14b for a distance beyond first side wall 14a. Bottom wall 14d is configured to support a portion of the lower surface 20B of cross element 20 when first end 20C of cross element 20 is received in the aperture 14e. First end 20C of cross element abuts an inner surface of second side wall 14b.

Deck 14 further includes a base 18 extending between first, second, third, and fourth elements 14A, 14B, 14C, 14D of the frame of deck 14. Base 18 is made of a composite material, which allows for trailer 10 to be of a lighter weight than if base 18 was made of other materials. Base 18 comprises a substantially continuous single sheet of the composite material. The engagement between base 18 and the frame of deck 14 is such as to ensure base 18 is leak proof. Base 18 has a first end 18A, a second end 18B, a first side 18C, and a second side 18D. First end 18A, second end 18B, first side 18C and second side 18D define a perimeter of base 18. First and second ends 18A, 18B are located a distance longitudinally apart from one another. First and second sides 18C, 18D are located a distance laterally apart from one another. Base 18 further includes a lower surface 18E and an upper surface 18F.

Base 18 is placed onto the upper surfaces of the various cross elements 20 of the frame of deck 14, such as onto upper surface 20A of cross element 20. As shown in FIG. 8, when first end 20C of cross element 20 is inserted into the aperture 14e defined in first element 14A, first end 18A of base 18 is contiguous with an inner wall 14A′ of first element 14A, second end 18B of base 18 is contiguous with an inner wall 14B′ of second element 14B, first side 18C of base 18 is contiguous with an inner wall 14C′ of third element 14C, and second side 18D of base 18 is contiguous with an inner wall 14D′ of fourth element 14D. Lower surface 18E of base 18 is contiguous with the upper surface 20A of cross element 20.

Referring now to FIGS. 2 and 8, a portion of each of the first, second, third, and fourth elements 14A, 14B, 14C, 14D of the frame of deck 14 extends upwardly beyond the upper surface 18F of base 18. The engagement between base 18 and each first, second, third, and fourth elements 14A, 14B, 14C, 14D is such that the elements 14A through 14D form a peripheral wall which surrounds base 18. Base 18 and deck 14 thereby present a substantially continuous and unbroken surface where any liquid which might be accidentally spilled on base 18 is not able to leak through or leave the boundaries of base 18. Effectively, the base 18 is sealed around its perimeter to the deck frame by virtue of insertion of the perimeter of base 18 into the apertures defined by the first, second, third, and fourth elements 14A through 14D, and the upwardly extending peripheral wall formed by first, second, third, and fourth elements 14A, 14B, 14C, 14D.

In one specific embodiment, trailer 10 may further include a seal provided on the upper surface of the perimeter of base 18 which sealingly secures base 18 to each of first, second, third, and fourth elements 14A, 14B, 14C, 14D.

Referring to FIGS. 1-2, 4-5 and 9, trailer 10 includes a plurality of supports 22 extending between and securing the frame of deck 14 to the frame of bed 12. The supports 22 are spaced a first distance “D1” apart from one another. A front support 22A of the plurality of support 22 is spaced a second distance “D2” away from first member 12A of frame of bed 12 and a rear support 22B of the plurality of support 22 is spaced a third distance “D3” away from second member 12B of frame of bed 12. One or more of the supports 22 includes a strengthening brace (not numbered) extending outwardly therefrom and engaging the frame of deck 14.

Referring to FIGS. 3-5, the distance between top 10C of trailer and the bottom of the wheel assemblies defines a third height “H3” or an overall height of trailer 10. The vertical distance between the upper surface of bed 12 and the lower surface of deck 14 of trailer 10 defines a fourth height “H4” which is substantially equal to a length of each of the plurality of supports 22.

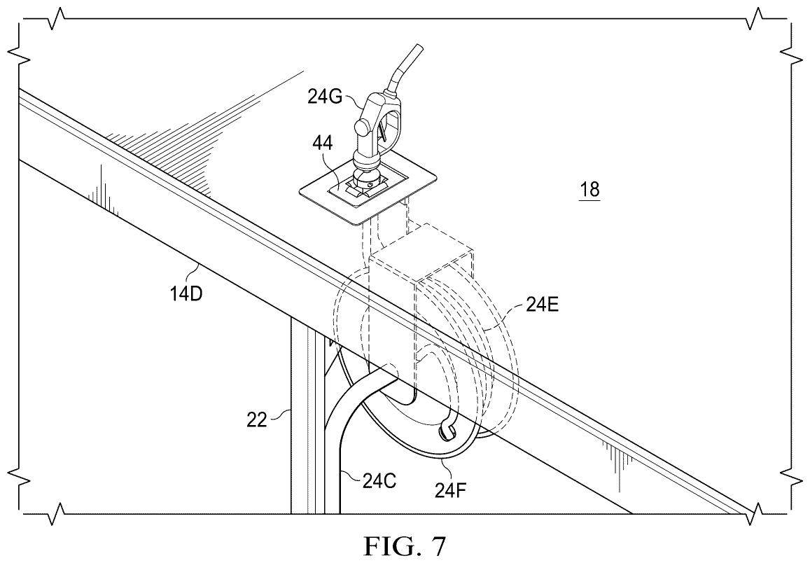

Referring to FIGS. 1-5, trailer 10 includes various equipment mounted to one or both of the bed 12 and deck 14. The equipment is mounted to the trailer in such a way that the equipment is open to the surrounding environment. The trailer 10 includes a plumbing assembly 24 mounted on bed 12. As illustrated, plumbing assembly 24 includes a first tank 24A and a second tank 24B located atop floor 16 and fixedly secured to floor 16 and/or to the frame of the bed 12 in any suitable manner. First tank 24A is adapted to hold a volume of a first liquid therein. Second tank 24B is adapted to hold a volume of a second liquid therein. First and second tanks 24A, 24B are operably engaged with one another via a plurality of hoses and valves, generally indicated by the reference number 24C. The plurality of hoses and valves 24C allows a liquid to be moved between first and second tanks 24A, 24B. Plumbing assembly 24 further includes a pump 24D which is fixedly secured to bed 12 and is operably engaged with first tank 24A, second tank 24B and the plurality of hoses and valves 24C. Plumbing assembly 24 further includes a hose 24E, a hose reel 24F and a nozzle 24G, which will be described later herein. Pump 24D is actuated when it is desired to move liquid between first tank 24A and second tank 24B via the plurality of hoses and valves 24C and is further actuated to move liquids from one of both of the first tank 24A and second tank 24B to the hose 24E on hose reel 24F. Hose 24E is retractably wound on hose reel 24F (FIGS. 4 and 7) and extends to the nozzle 24G which extends upwardly and outwardly from deck 14 of trailer 10. A flow of the liquid from the plumbing assembly 24 is controlled via a nozzle 24G located at an end of hose 24E. Nozzle 24G includes a handle and a lever to allow a user to control the flow of the liquid delivered from the plumbing assembly 24.

In one specific embodiment, first tank 24A may be an induction tank capable of housing a chemical mixing mechanism and configured to receive a quantity of a chemical therein. Second tank 24B may be a clear water tank. The first tank 24A may be a 175 gallon induction tank and the second tank 24B may be a 1000 gallon clear water tank. Pump 24D may be a 2 inch pump capable of pumping 200 gallons of liquid per minute from one or both of first tank 24A and second tank 24B.

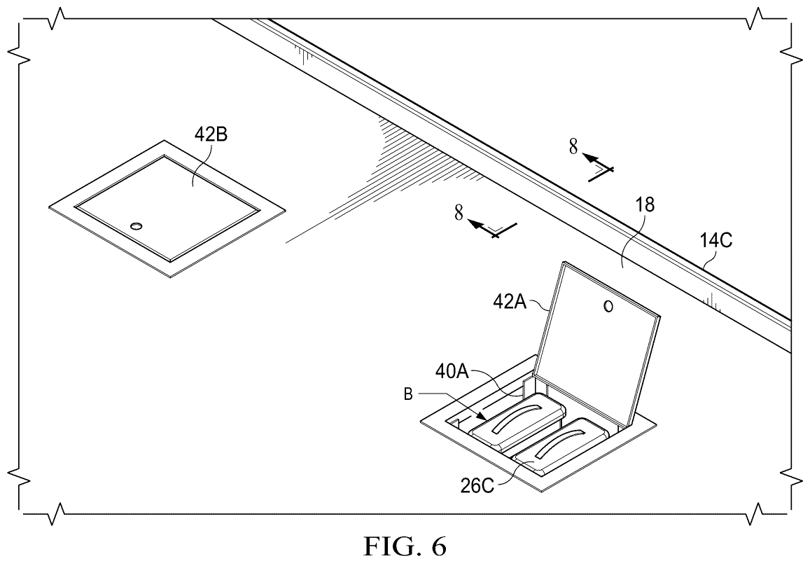

Trailer 10 further includes an electrical assembly 26 mounted on bed 12. The electrical assembly 26 is configured to provide power to all of the equipment provided on trailer 10 that needs to be powered. For example, the electrical assembly 26 is configured to provide power to pump 24D. Electrical assembly 26, as illustrated, includes a first generator 26A and a second generator 26B located atop floor 16 and fixedly secured to one or both of floor 16 and the frame of bed 12. First generator 26A and second generator 26B are also operably engaged with a first battery charger 26C and a second battery charger 26D, respectively. First and second battery chargers 26C, 26D are mounted on deck 14 and are utilized to charge batteries for agricultural drones. First and second generators 26A, 26B are connected to first and second battery chargers 26C, 26D via a first electrical cord 26E and a second electrical cord 26F, respectively. First and second battery chargers 26C, 26D are each adapted to receive a least one drone battery “B” (FIGS. 4 and 6) therein.

Although not illustrated in the attached figures, it will be understood that trailer 10 may additionally include a plurality of lights on one or both of the bed 12 and deck 14. The plurality of lights may be configured to receive electrical power from first and/or second generators 26A, 26B and may be controlled by one or more switches (not shown).

Deck 14 includes a railing 28 extending outwardly from a portion of first, second, and third elements 14A, 14B, 14C. Railing 28 forms a perimeter around the portion of first, second, and third elements 14A, 14B, 14C to help prevent a user from falling off the deck 14. It will be understood that sections of railing may be provided elsewhere on deck 14 to help ensure the safety of the user. Deck 14 further includes a post 30 and a wall 32 extending upwardly from base 18. The wall extends between a portion of the railing 28 and the post 30. Railing 28, post 30 and wall 32 together define a safety zone 34, which will be described in more detail below regarding the use of trailer 10. Railing 28 and wall 32 are each adapted to receive and hold a drone controller “C” thereto.

In one specific embodiment, wall 32 is engaged with base 18 via a hinge (not shown) to allow a user to selectively pivot wall 32 into contact with the upper surface of the base 18 when wall 32 is not required or when trailer 10 is to be towed. Wall 32 may be secured in an upright position, as shown in FIGS. 1-9, via a set of locks (not shown) located on railing 28 and post 30. Although not illustrated in the attached figures, base 18 may additionally define an umbrella holder within the safety zone 34. The umbrella holder may comprise a recess formed in the deck 14 where the recess is sized and shaped to receive a lower end of an umbrella therein in order provide shade to the user while located on deck 14 in safety zone 34. Although not illustrated in the attached figures, trailer 10 may also have a safety harness operably engaged with deck 14. Safety harness may be selectively secured to the user to help prevent the user from falling from deck 14, particularly when out of the safety zone 34.

Referring to FIGS. 1-3, deck 14 defines a hole (not numbered) which extends from an upper surface to a lower surface of the deck 14 proximate the safety zone 34. The hole is located immediately above a staircase 36 which extends between the bed 12 and deck 14. Staircase 36 extends outwardly from a top surface of bed 12 at an angle “α” (FIG. 4). Staircase 36 intersects with a lower surface of base 18 of deck 14 proximate the hole in the deck 14. In one specific embodiment, angle “α” is equal to about 45-75 degrees. More specifically, angle “α” is equal to about 50-70 degrees. Even more specifically, angle “α” is equal to about 55-65 degrees. Most specifically, angle “α” is equal to about 60 degrees.

A door 38 is provided to restrict access to the hole proximate the staircase 36. The door 38 is pivotably engaged with a door frame (not numbered) mounted to the deck 14 via a set of hinges 38A. Door 38 is selectively movable between an open position and a closed position. Door 38 is opened to allow the user to climb up onto deck 14 from staircase 36 or to climb down onto the staircase 36 to return to bed 12. Door 38 is closed when the user is on the deck 14 or when the trailer 10 is being towed. It will be understood that the door frame (not numbered) is configured to engage a portion of base 18 and deck 14 in such a way as to seal the base 18 around the perimeter of the hole, and thereby help ensure that the base 18 is leak proof.

Referring to FIGS. 1-3 and 5-6, deck 14 further defines a first opening and a second opening (not numbered) spaced a distance away from the door 38. The first opening and second opening extends from the upper surface to the lower surface of the deck 14. A first holder 40A for the first battery charger 26C is mounted to the underside of deck 14 immediately below the first opening. Similarly, a second holder 40B for the second battery charger 26B is mounted to the underside of the deck 14 immediately below the second opening. A first hatch 42A is pivotally mounted to a hatch frame (not numbered) engaged with the deck 14 proximate the first opening. A second hatch 42B is pivotally mounted to a hatch frame (not numbered) engaged with the deck 14 proximate the second opening. First and second hatches 42A, 424B are able to be moved to an open position to allow the user to selectively access the first and second battery chargers 26C, 26D which are located within first and second holders 40A, 40B.

It will be understood that the hatch frames (not numbered) for the first and second hatches 42A, 42B are configured to engage a portion of base 18 and deck 14 in such a way as to seal the base 18 around the perimeter of the first and second openings for the hatches 42A, 42B, and thereby help ensure that the base 18 is leak proof.

Referring to FIGS. 1-3 and 7, deck 14 further includes an aperture 44 defined in the base 18 and extending from the upper surface to the lower surface of the deck 14. Aperture 44 is configured to receive the nozzle 24G of the plumbing assembly 24 therethrough. An appropriate support mechanism (not shown) for nozzle 24G is mounted on deck 14. The support mechanism holds nozzle 24G in a suitable position to enable a user to access the nozzle 24G when standing on the deck 14. It will be understood that aperture 44 is surrounded by a frame (not numbered) configured to engage a portion of base 18 and deck 14 in such a way as to seal the base 18 around the perimeter of the aperture 44, and thereby help ensure that the base 18 is leak proof.

Referring to FIGS. 1-3, deck 14 includes at least one drone anchor 46 operably engaged with base 18. Anchor 46 is configured to enable a drone “D” (FIG. 1) to be secured to deck 14. Anchor 46 is further configured to be operable to release drone “D” therefrom.

In one specific embodiment, anchor 46 may be a D-ring tie down and a leather strap configured to wrap around a portion of the drone and be secured back on itself via a belt buckle-style connector.

Referring still to FIGS. 1-3, deck 14 further includes one or more electrical outlets 48 configured to be operably engaged with electrical assembly 26 on bed 12. Electrical outlet 48 is configured to supply electrical power to the deck 14 and thereby enable the user to utilize power for any of a variety of reasons, such as to charge the drone controller “C”.

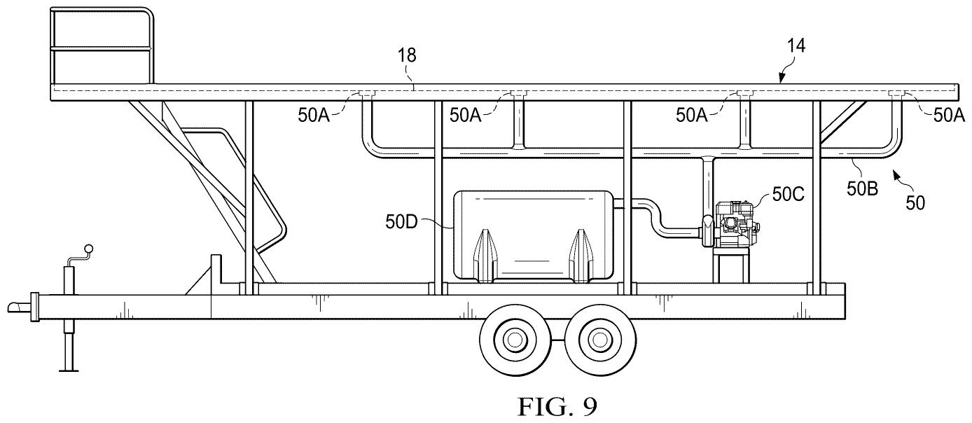

Referring to FIG. 9, trailer 10 is shown to include an optional drainage assembly 50. It should be understood that all equipment other than drainage assembly 50 has been omitted from FIG. 9 for clarity of illustration. Drainage assembly 50 includes a plurality of drains 50A extending through base 18 of deck 14. Each drain 50A connects to a series of pipes 50B that are able to transport any liquid that may be accidentally spilled on base 18 of deck 14 while using nozzle 24G to fill spray tanks provided on the drones “D”. The liquid captured by the drains 50A and moved through in the plurality of pipes 50B will be moved via a pump 50C to a containment vessel 50D. In some embodiments, instead of containment vessel 50D, the pipes 50B may terminate in the first tank 24A of plumbing assembly 24.

In one specific embodiment, trailer 10 with plumbing assembly 24 and electrical assembly 26 has a tongue weight percentage of about XX-XX with first and second tanks 24A, 24B of plumbing assembly 24 empty. Trailer 10 with plumbing assembly 24 and electrical assembly 26 has a tongue weight percentage of about XX-XX with first and second tanks 24A, 24B of plumbing assembly 24 full. The tongue weight percentage of the trailer with trailer 10 with plumbing assembly 24 and electrical assembly 26 is between XX-XX.

Referring to FIGS. 2, 3 and 5, first and second tongue beams 12E, 12F extend for a distance equal to a third length “L3” (FIG. 5) from first and second frame members 12A, 12B.

First member 12A of bed 12 and first element 14A of deck 14 are a fourth distance “D4” apart from one another horizontally. Second member 12B of bed 12 and second element 14B of deck 14 are a fifth distance “D5” apart from one another horizontally.

Railing 28, post 30, and wall 32 extend upwardly from a top of the portion of first, third, and fourth elements 14A, 14C, 14D for a fifth height “H5” (FIG. 5). Post 30 and wall 32 are spaced a sixth distance “D6” (FIG. 5) away from first element 14A.

In one embodiment, first length “L1” is equal to about 249-273 inches. More specifically, first length “L1” is equal to about 255-267 inches. Even more specifically, first length “L1” is equal to about 258-264 inches. Most specifically, first length “L1” is equal to about 261 inches.

Second length “L2” is equal to about 372-396 inches. More specifically, second length “L2” is equal to about 378-390 inches. Even more specifically, second length “L2” is equal to about 381-387 inches. Most specifically, second length “L2” is equal to about 384 inches.

Third length “L3” is equal to about 60-84 inches. More specifically, third length “L3” is equal to about 66-78 inches. Even more specifically, third length “L3” is equal to about 69-75 inches. Most specifically, third length “L3” is equal to about 72 inches.

In one embodiment, first width “W1” (FIG. 2) is equal to about 89-113 inches. More specifically, first width “W1” is equal to about 95-107 inches. Even more specifically, first width “W1” is equal to about 98-104 inches. Most specifically, first width “W1” is equal to about 101 inches.

Second width “W2” is equal to about 89-113 inches. More specifically, second width “W2” is equal to about 95-107 inches. Even more specifically, second width “W2” is equal to about 98-104 inches. Most specifically, second width “W2” is equal to about 101 inches.

In one embodiment, first height “H1” is equal to about 2.5-7.5 inches. More specifically, first height “H1” is equal to about 3.5-6.5 inches. Even more specifically, first height “H1” is equal to about 3-6 inches. Most specifically, first height “H1” is equal to about 5 inches.

Second height “H2” is equal to about 3.5-10.5 inches. More specifically, second height “H2” is equal to about 5-9 inches. Even more specifically, second height “H2” is equal to about 6-7 inches. Most specifically, second height “H2” is equal to about 7 inches.

Third height “H3” is equal to about 118-190 inches. More specifically, third height “H3” is equal to about 130-178 inches. Even more specifically, third height “H3” s equal to about 142-166 inches. Most specifically, third height “H3” is equal to about 154 inches.

Fourth height “H4” is equal to about 70-94 inches. More specifically, fourth height “H4” is equal to about 76-88 inches. Even more specifically, fourth height “H4” is equal to about 79-85 inches. Most specifically, fourth height “H4” is equal to about 82.31 inches.

Fifth height “H5” is equal to about 20-44 inches. More specifically, fifth height “H5” is equal to about 26-38 inches. Even more specifically, fifth height “H5” is equal to about 29-35 inches. Most specifically, fifth height “H5” is equal to about 38.69 inches.

In one specific embodiment, first distance “D1” is equal to about 65-89 inches. More specifically, first distance “D1” is equal to about 71-83 inches. Even more specifically, first distance “D1” is equal to about 74-80 inches. Most specifically, first distance “D1” is equal to about 77 inches.

Second distance “D2” is equal to about 7.5-13.5 inches. More specifically, second distance “D2” is equal to about 8.5-12.5 inches. Even more specifically, second distance “D2” is equal to about 9.5-11.5 inches. Most specifically, second distance “D2” is equal to about 10.5 inches.

Third distance “D3” is equal to about 7.5-13.5 inches. More specifically, third distance “D3” is equal to about 8.5-12.5 inches. Even more specifically, third distance “D3” is equal to about 9.5-11.5 inches. Most specifically, third distance “D3” is equal to about 10.5 inches.

Fourth distance “D4” is equal to about 60-84 inches. More specifically, fourth distance “D4” is equal to about 66-78 inches. Even more specifically, fourth distance “D4” is equal to about 69-75 inches. Most specifically, fourth distance “D4” is equal to about 72 inches.

Fifth distance “D5” is equal to about 36-60 inches. More specifically, fifth distance “D5” is equal to about 42-54 inches. Even more specifically, fifth distance “D5” is equal to about 45-51 inches. Most specifically, fifth distance “D5” is equal to about 48 inches.

Sixth distance “D6” is equal to about 36-60 inches. More specifically, sixth distance “D6” is equal to about 42-54 inches. Even more specifically, sixth distance “D6” is equal to about 45-51 inches. Most specifically, sixth distance “D6” is equal to about 48 inches.

Having now described trailer 10, a method of using the trailer 10 to operate an agricultural drone “D” will be described in more detail.

A user engages trailer 10 to vehicle “V” (FIG. 1) via the hitch assembly 12G. It will be understood that while vehicle “V” is illustrated as being a pick-up truck, any other type of moving apparatus may be used instead of a truck. For example, the vehicle “V” may be a tractor.

The user loads trailer 10 with the needed equipment. For example, the chemicals to be sprayed on the crops/fields will be loaded into the first tank 24A and the second tank 24B is filled with clean water. Additionally, one or more drones “D” are positioned on deck 14 atop base 18. The user secures the one or more drones “D” to base 18 and thereby trailer 10 by utilizing anchors 46. Additionally, the user will load battery chargers 26C, 26D into the holders 40A, 40B, respectively and will ensure the battery chargers 26C, 26D are operatively engaged with the electrical assembly. Batteries “B” for drones “D” are loaded into the battery chargers 26C, 26D for charging.

After trailer 10 is loaded with the necessary equipment, the user hooks hitch assembly 12G to vehicle “V” and moves trailer 10 via vehicle “V” to a desired location for operating drones “D” to spray agricultural chemicals onto crops/fields. At the desired location, the user then accesses the charged drone batteries “B” stored within battery chargers 26C, 26D and places one or more drone batteries “B” into each drone “D” that is to be used. The user will access the desired liquid(s) located in one or both of the first and second tanks 18A, 18B by powering pump 24D and moving the desired liquid(s) through the plurality of hoses and valves 24C to the hose 24E on the hose reel 24F. It will be understood that the water from the second tank 24B may be pumped, by pump 24D into first tank 24A, and a mixing mechanism in the first tank 24A may mix chemicals in the tank with the water as needed. The user fills a storage tank on each drone “D” with the desired liquid utilizing nozzle 24G.

The user releases at least one drone “D” from its anchors 46 and then, moving to the safety zone 34, begins to operate the drone “D” utilizing the drone controller “C”. During operation of drone “D”, the user may secure controller “C” on the railing 28 or wall 32 using one or more mounting brackets 52. The mounting brackets 52 may be permanently or temporarily provided on the railing 28, the wall 32, or may be mounted on the controller “C”. Engagement of the controller “C” on the railing 28 or wall 32 via the mounting bracket(s) 52 enables the user to operate the drone “D” from within the safety zone 34. Alternatively, the controller “C” may be hand-held during control and operation of the drone “D”. The drone “D” may be operated from within the safety zone 34, or from elsewhere on the bed 12 or deck 14, or from the ground adjacent the trailer 10. Ideally, the drone “D” should be operated from the deck 14, and most particularly from the safety zone 34 on the deck 14, to give the user the best view of the crops or fields to be sprayed. The user will fly the drone “D” over the crops or field to be sprayed and will activate the drone “D” to dispense the desired liquid from the storage tank on the drone “D”, and thereby spray the desired liquid over the crops or field as the drone flies over the same.

When the drone batteries “B” need recharging or when spraying the crops or fields with the drone “D” is completed, the user lands the drone “D” atop base 18. The user removes the drone batteries “B” from the drone “D” and places the drone batteries “B” into the battery chargers 26C, 26D. Battery chargers 26C, 26D then recharge the drone batteries “B”.

If the user is finished using drone “D”, the user will secure drone “D” to deck 14 utilizing anchor 46.

Because base 18 is a continuous, substantially unbroken sheet of material (apart from the openings for the door 38, the hatches 42A, 42B, and the aperture 44), if the user accidentally spills any liquid on the base 18 during dispensing of liquid into the drones “D” or at any other time, the spilled liquid will not flow from the deck 14 onto bed 12 and/or onto the equipment mounted on bed 12. Any potentially toxic chemicals in the spilled liquid are thereby prevented from spilling onto bed 12 or any equipment mounted on bed 12. Furthermore, any spilled liquid is also retained on the upper surface base 18 by the peripheral wall created by the first, second, third and fourth elements 14A, 14B, 14C, 14D. This arrangement makes it relatively easy to clean up any spilled liquid from base 18.

In some embodiments, such as that shown in FIG. 9, drainage holes 50A may be defined in base 18. As described earlier herein, the drainage holes 50A are connected via pipes 50B to a containment vessel 50D. If liquid is spilled onto base 18, the pump 50C may be activated to move liquid flowing into the draining holes 50A into the containment vessel 50D (or, in some instances, back into first tank 24A).

It should also be noted that by positioning the hose reel 24F, the hose 24E, and the battery chargers 26C, 26D under the lower surface of the deck 14, the overall center of gravity of the trailer 10 is lowered. Additionally, since the hose reel 24F and battery chargers 26C, 26D are not on the deck, the number of tripping hazards on the upper surface of the deck is reduced, making it safer for the drone operator(s).

The device, assembly, or system of the present disclosure may additionally include one or more sensors to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

If sensors are utilized to gather data relating to the device, assembly, or system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the device, assembly, or system of the present disclosure. In one embodiment, the device, assembly, or system of the present disclosure can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the device, assembly, or system of the present disclosure can use the sensors to acquire a representation of the real-world environment (e.g., a physical environment) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., depth maps), classification data identifying objects in the scene or surrounding environment, properties or classification data of components of the device, assembly, or system of the present disclosure, or some combination thereof. Generally, the sensor model learns to predict sensor data from a representation of the scene, environment or operation of the device, assembly, or system of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the device, assembly, or system of the present disclosure may collect sensor data by fusing sensors as the vehicle traverses a real-world environment. The sensors of the device, assembly, or system of the present disclosure may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the vehicle), vibration sensors, steering sensors, brake sensors (e.g., as part of the brake sensor system), and/or other sensor types.

In another embodiment, training data for the sensor model is generated based on simulated or virtual environments. The training data may then be used to train the sensor model for use in real-world autonomous applications, e.g., to control the operation of the device, assembly, or system of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

The device, assembly, or system of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the device, assembly, or system of the present disclosure. In one example, the autonomous hardware, software, and/or firmware can be installed in and used to control the device, assembly, or system of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the device, assembly, or system of the present disclosure and/or stored in the data store. The training system can also incorporate or train up-to-date, real-time neural networks (and/or other machine learning models) for one or more sensor models.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the device, assembly, or system of the present disclosure may differ from embodiment to embodiment. In one embodiment, alerts and signals from the device, assembly, or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular device, assembly, or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the device, assembly, or system of the present disclosure may also be sent to a work tracking system that allows the individual, or the organization for which he or she works, to track the status of the various alerts that are received, to schedule particular workers to repair a particular device, assembly, or system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, the first and second holders 40A, 40B can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the device, assembly, or system of the present disclosure, which may include the logic(s) presented herein, includes the features, components, techniques or processes detailed herein that, as combined, accomplished the desired results detailed herein. These specific elements, configuration or techniques of the device, assembly, or system of the present disclosure, some of which may be included in at least one of the appended claims, accomplish these desired results to overcome the then existing problems in the relevant field of computer processor-based systems. Additionally, the features, components, techniques or processes of the device, assembly, or system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the device, assembly, or system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A trailer for use with a drone comprising:
a bed adapted to be engaged with a moving apparatus;
a deck located vertically above the bed and operably engaged with the bed;
a base provided on the deck; and
wherein the base comprises a substantially continuous single sheet of material.

2. The trailer according to claim 1, wherein the base is comprised of a single sheet of a composite material.

3. The trailer according to claim 1, wherein the base has a perimeter which is sealed to a frame of the deck.

4. The trailer according to claim 3, wherein the frame of the deck defines a peripheral wall extending upwardly beyond the perimeter of the base.

5. The trailer according to claim 1, wherein the base is leak proof.

6. The trailer according to claim 1, further comprising an anchor provided on the deck, wherein the anchor is adapted to engage and secure a drone to the deck.

7. The trailer according to claim 1, further comprising:
a staircase extending between the bed and the deck.

8. The trailer according to claim 7, further comprising:
a hole defined in the deck proximate the staircase; and
a door operably engaged with the deck, wherein the door is movable between an open position and a closed position, and when in the open position, access to the staircase is enabled.

9. The trailer according to claim 1, further comprising equipment mounted on the bed, wherein the equipment is open to the environment.

10. The trailer according to claim 9, wherein the equipment comprises one or more of a plumbing assembly and an electrical assembly.

11. The trailer according to claim 10, wherein the plumbing assembly comprises a hose reel mounted on the deck, wherein the hose reel is positioned below a lower surface of the deck.

12. The trailer according to claim 11, wherein the plumbing assembly further comprises:
a first tank adapted to hold a volume of a first liquid;
a second tank adapted to hold a volume of a second liquid; and
a pump operably engaged with one or both of the first tank and the second tank.

13. The trailer according to claim 12, wherein the plumbing assembly further comprises a nozzle provided on the deck and connected to a hose mounted on the hose reel, wherein the hose and nozzle are operably engaged with the one or both of the first tank and the second tank.

14. The trailer according to claim 10, wherein the electrical assembly comprises at least one battery charger operably engaged with the deck, wherein the at least one battery charger is mounted below a lower surface of the deck.

15. The trailer according to claim 14, wherein the electrical assembly further comprises:
a generator located on the bed; and
wherein the at least one battery charger is operably engaged with the generator.

16. The trailer according to claim 1, further comprising a railing extending upwardly around at least a portion of the deck, wherein the railing defines a safety zone for an operator on the deck.

17. The trailer according to claim 16, further comprising a mounting bracket on the railing, wherein the mounting bracket is adapted to operably engage a controller for the drone to the railing.

18. A method of using a trailer for use with a drone, comprising:
providing the trailer having a bed;
engaging a deck vertically above the bed;
providing a base on the deck, wherein the base is leak proof;
engaging the trailer to a moving apparatus via the bed;
placing a drone atop the base;
moving the trailer via the moving apparatus to a desired position; and
operating a drone from the deck of the trailer.

19. The method of claim 18, further comprising:
providing an anchor on the deck; and
releasably securing the drone to the deck via the anchor.

20. The method of claim 18, further comprising:
providing a plumbing assembly on the trailer;
positioning a hose reel of the plumbing assembly below a lower surface of the deck;
securing the hose reel to the deck of the trailer;
providing a nozzle of the plumbing assembly above the deck;
operably engaging the nozzle with a hose located on the hose reel; and
filling the drone with a desired liquid via the nozzle.

21. The method of claim 18, further comprising:
providing an electrical assembly on the trailer;
providing a battery charger as part of the electrical assembly; and
accessing the battery charger while standing atop the deck.

22. The method of claim 21, further comprising:
positioning a holder for the battery charger below a lower surface of the deck;
securing the holder to the deck; and
inserting the battery charger into the holder.

23. The method of claim 18, wherein providing the base on the deck comprises:
engaging a single continuous sheet of material on an upper surface of the deck.
